(19) United States
(12) Patent Application Publication
(10) Pub. No.: US 2018/0071683 A1
(43) Pub. Date: Mar. 15, 2018

(54) WATER TREATMENT DEVICE

(71) Applicant: MITSUBISHI HEAVY INDUSTRIES, LTD., Tokyo (JP)

(72) Inventors: Hidemasa Kakigami, Tokyo (JP); Yoshiaki Ito, Tokyo (JP); Katsuhiko Yokohama, Tokyo (JP); Hideo Iwahashi, Tokyo (JP); Takayoshi Hori, Yokohama-shi (JP); Katsunori Matsui, Yokohama-shi (JP)

(73) Assignee: MITSUBISHI HEAVY INDUSTRIES, LTD., Tokyo (JP)

(21) Appl. No.: 15/558,721

(22) PCT Filed: Mar. 20, 2015
(86) PCT No.: PCT/JP2015/058436

§ 371 Date: Sep. 15, 2017

(51) Int. Cl. B01D 61/02; B01D 61/08; B01D 61/12; C02F 1/44

(52) U.S. Cl. CPC B01D 61/022; B01D 61/025; B01D 61/08; C02F 2103/08; C02F 1/441; B01D 2317/04; B01D 61/12

(57) ABSTRACT

A water treatment device (1) includes a primary unit (U1) having a plurality of primary elements (E1) as reverse osmosis membrane devices disposed in parallel to each other to separate water to be treated (SW) supplied from an upstream side into primary condensed water (CW1) and fresh water (FW1); a pump (P) which feeds the water to be treated from the upstream side of the primary unit to supply the water to be treated to the primary unit; a secondary unit (U2) having secondary elements (E2) as reverse osmosis membrane devices, the secondary elements being provided in smaller number than the primary elements and disposed in parallel to each other to separate the primary condensed water into secondary condensed water (CW2) and fresh water (FW2); and a reflux unit (2) which refluxes a part of the secondary condensed water between the primary unit and the secondary unit.

### TECHNICAL FIELD

The present invention relates to a water treatment device.

### BACKGROUND ART

As a technique for performing desalination of sea water or purification of industrial water, a water treatment device using a reverse osmosis membrane has been put to practical use. As a specific example thereof, a technique described in the following Patent Literature 1 is known. The membrane treatment device described in Patent Literature 1 has a membrane module bank on an upstream stage side and a membrane module bank on a downstream stage side each having a plurality of membrane modules, and a pump which feeds raw water (water to be treated) to the membrane module bank on the upstream stage side.

In such a device, a target value is previously determined with respect to a ratio of fresh water (fresh water recovery rate) recovered from the water to be treated such as sea water. When the fresh water recovery rate is excessively high, the concentration of salt contained in the condensed water, which is a remaining component from which fresh water has been separated, excessively rises. When condensed water of a high salt concentration is discharged into the environment, there is concern about an increase in an environmental burden. Therefore, for example, when sea water is desalinated, the fresh water recovery rate is set to about 25 to 40%.

On the other hand, when the capability of the reverse osmosis membrane declines with the continuous operation of the device, the fresh water recovery rate relatively decreases. In this case, it is necessary to compensate for the decrease in the fresh water recovery rate by increasing the supply pressure of the water to be treated to the reverse osmosis membrane. When the output of the pump is increased to increase the fresh water recovery rate, the supply pressure of the water to be treated to the reverse osmosis membrane rises. As the pressure of the water to be treated rises, the amount of fresh water separated in the reverse osmosis membrane increases and the fresh water recovery rate starts to increase.

### CITATION LIST

### Patent Literature

### [Patent Literature 1]

Japanese Unexamined Patent Application, First Publication No. 2013-22544

### SUMMARY OF INVENTION

### Technical Problem

However, as the fresh water recovery rate rises as described above, the amount of condensed water separated from the water to be treated decreases. That is, in the device described in the above-mentioned Patent Literature 1, the amount of condensed water supplied from the membrane module bank on the upstream stage side to the membrane module bank on the downstream stage side decreases. Furthermore, in the device using the reverse osmosis membrane, a lower limit value is set for the amount of condensed water (flow rate) discharged per element. If the amount of condensed water falls below the lower limit value, defects such as scale precipitation occur due to an increase in membrane surface concentration caused by concentration polarization in the membrane module, and there is a possibility that sufficient separation and condensation cannot be performed. Therefore, in the device described in the above-mentioned Patent Literature 1, the fresh water recovery rate becomes limited.

The present invention has been made in view of the above circumstances, and an object thereof is to improve the fresh water recovery rate and the operation rate in the water treatment device.

### Solution to Problem

The present invention includes the following aspects in order to solve the above problem.

According to a first aspect of the present invention, a water treatment device includes a primary unit having a plurality of primary elements as reverse osmosis membrane devices disposed in parallel to each other to separate water to be treated supplied from an upstream side into primary condensed water and fresh water; a pump which feeds the water to be treated from the upstream side of the primary unit to supply the water to be treated to the primary unit; a secondary unit having secondary elements as reverse osmosis membrane devices, the secondary elements being provided in smaller number than the primary elements and disposed in parallel to each other to separate the primary condensed water into secondary condensed water and fresh water; and a reflux unit which refluxes a part of the secondary condensed water between the primary unit and the secondary unit.

In the water treatment device as described above, by increasing the output of the pump, the ratio (fresh water recovery rate) of the fresh water collected from the secondary unit to the deposition of the water to be treated increases. When the fresh water recovery rate increases, the amount of secondary condensed water discharged from each secondary element decreases in the secondary unit.

Here, in the reverse osmosis membrane device such as the primary element and the secondary element, the lower limit value is set for the amount of the condensed water to be discharged. In the water treatment device, a part of the secondary condensed water can be refluxed between the primary unit and the secondary unit via the reflux unit. Therefore, even when the fresh water recovery rate increases, condensed water of an amount exceeding the aforementioned lower limit value can be obtained for each secondary element in the secondary unit.

According to the second aspect of the present invention, in the water treatment device according to the first aspect, the reflux unit may include a reflux line through which the secondary condensed water flows, by connecting the downstream side of the secondary unit and the upstream side of the secondary unit; and a reflux pump provided on the reflux line to feed the secondary condensed water flowing through the reflux line toward the upstream side of the secondary unit.

In the water treatment device as described above, the pressure of the primary condensed water on the upstream side of the secondary unit is higher than the pressure of the secondary condensed water on the downstream side of the secondary unit. Here, by providing the reflux pump as described above, it is possible to apply pressure to the secondary condensed water in the reflux line. As a result, the secondary condensed water can be stably refluxed toward the upstream side of the secondary unit through the reflux line.

According to a third aspect of the present invention, the water treatment device according to the first or second aspect may include a bypass line which bypasses a part of the water to be treated from a section between the pump and the primary unit to a section between the primary unit and the secondary unit.

According to the above configuration, even when the fresh water collection rate increases, that is, even when the amount of the secondary condensed water discharged from the secondary unit is reduced, a part of the water to be treated can be bypassed to the upstream side of the secondary unit (between the primary unit and the secondary unit) through the bypass line, without going through the primary unit. As a result, a part of the water to be treated can be guided to the secondary unit as the primary condensed water.

According to a fourth aspect of the present invention, the water treatment device according to any one of the above aspects may include a measuring unit which measures characteristic value of at least one of the water to be treated, the primary condensed water, the secondary condensed water, and the fresh water; and a control unit which controls reflux of the secondary condensed water by the reflux unit, on the basis of a comparison between a Langeliar saturation index obtained from the characteristic value and a predetermined reference value.

According to a fifth aspect of the present invention, in the water treatment device according to the fourth aspect, the characteristic value may be a temperature or electric conductivity in at least one of the water to be treated, the primary condensed water, the secondary condensed water, and the fresh water, and the control unit may include a calculating unit which calculates the Langeliar saturation index on the basis of the temperature and the electric conductivity.

According to the above configuration, it is possible to maximize the fresh water recovery rate of the water treatment device depending on the quality of water in at least one of the water to be treated, the primary condensed water, the secondary condensed water, and the fresh water. In particular, by providing the measuring unit and the control unit, the capability of the water treatment device against a change in water quality due to seasonal variations or the like can be autonomously adjusted, and thus it is possible to flexibly respond to the change.

### Advantageous Effects of Invention

According to the water treatment device of the present invention, it is possible to improve the fresh water recovery rate and the operation rate.

### BRIEF DESCRIPTION OF DRAWINGS

FIG. 1 is a system diagram illustrating a water treatment device according to a first embodiment of the present invention.

FIG. 2 is a system diagram illustrating a water treatment device according to a second embodiment of the present invention.

FIG. 3 is a system diagram illustrating a water treatment device according to a modified example of the present invention.

### DESCRIPTION OF EMBODIMENTS

### First Embodiment

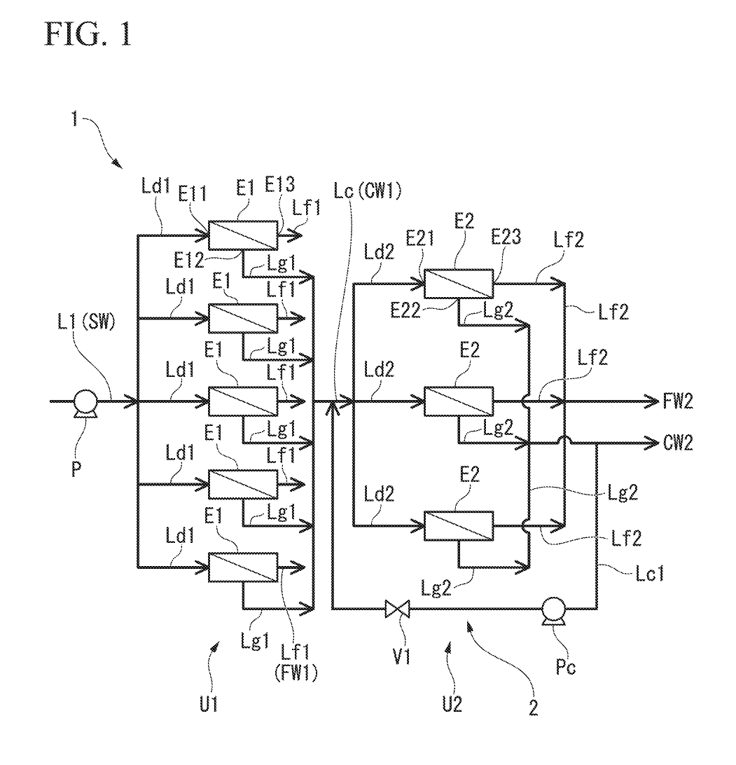

A first embodiment of the present invention will be described with reference to the drawings. As illustrated in FIG. 1, a water treatment device 1 according to the present embodiment includes a water intake line L1 through which water to be treated SW flows, a pump P which feeds the water to be treated SW from the upstream side to the downstream side of the water intake line L1, a primary unit U1 and a secondary unit U2 having a plurality of reverse osmosis membrane devices (a primary element E1, and a secondary element E2), and a connection line Lc which connects the primary unit U1 and secondary unit U2 to each other. Furthermore, the water treatment device 1 has a reflux unit 2 which refluxes a part of the secondary condensed water CW2 between the primary unit U1 and the secondary unit U2 (on the connection line Lc).

The water intake line L1 is a flow path which guides the water to be treated SW supplied from the outside to the water treatment device 1. On the upstream side of the water intake line L1, for example, a pretreatment device (not illustrated) is provided. In the pretreatment device, addition of an oxidizing agent for suppressing organisms contained in sea water from adhering to the device, or a flocculant for aggregating fine particles, colloids and the like, and adjustment of pH and the like are performed. More specifically, hypochlorous acid or the like is preferably used as the oxidizing agent. Further, an inorganic flocculant such as ferric chloride or a polymer flocculant such as PAC is used as the flocculant. The suspension agglomerated by the flocculant is removed by a sand filter.

The water to be treated SW subjected to the pretreatment as described above is fed from the upstream side toward the downstream side in the water intake line L1, by the pump P provided on the water intake line L1.

The primary unit U1 and the secondary unit U2 are devices for separating and condensing the water to be treated SW guided by the water intake line L1 by reverse osmosis. The primary unit U1 includes a plurality of primary elements E1 disposed in parallel to each other, a primary distribution line Ld1 which distributes the water to be treated SW in the water intake line L1 to the plurality of primary elements E1, and a primary water collection line Lg1 and a primary fresh water line Lf1 through which the primary condensed water CW1 and the fresh water (primary fresh water FW1) discharged from the primary element E1 flow, respectively.

The primary element E1 is a reverse osmosis membrane device including a reverse osmosis membrane (RO membrane) such as a hollow fiber membrane or a spiral membrane therein. Each of the primary elements E1 mainly includes an exterior member called a vessel, and a reverse osmosis membrane disposed inside the vessel. Furthermore, a primary flow inlet E11 connected to the distribution line, and a primary water collection port E12 and a primary fresh water collection port E13 connected to the primary water collection line Lg1 and the primary fresh water line Lf1, respectively, are provided in the vessel.

The primary unit U1 is configured by disposing the primary elements E1 in parallel to each other. As an example, in the present embodiment, five primary elements E1 are disposed in parallel. More specifically, the downstream end portion of the water intake line L1 and the primary flow inlet E11 of each primary element E1 are connected to each other by the distribution line. Further, the primary water collection line Lg1 connects the primary water collection port E12 of each primary element E1 and the upstream end portion of the connection line Lc (to be described later) to each other. The primary fresh water line Lf1 is a flow path for discharging and collecting fresh water separated in each primary element E1 to the outside. On the downstream side of the primary fresh water line Lf1, a tank for storing the recovered fresh water or facilities for performing further filtering etc. are connected (neither is illustrated). With the above configuration, the five primary elements E1 are in parallel to each other.

Further, in the embodiment, only an example in which the five primary elements E1 are provided is illustrated. However, the number of the primary elements E1 is not limited to five, but the number may be four or less, or six or more, as long as the number is larger than the number of the secondary elements E2 to be described later.

The secondary unit U2 is a device for further separating and condensing the primary condensed water CW1 generated in the primary unit U1 by the same configuration as the primary unit U1. More specifically, the secondary unit U2 includes a plurality of secondary elements E2 disposed in parallel to each other, a second distribution line Ld2 which distributes the primary condensed water CW1 generated in the primary unit U1 to the plurality of secondary elements E2, and a secondary water collection line Lg2 and a secondary fresh water line Lf2 through which the secondary condensed water CW2 discharged from the secondary element E2 and the fresh water (secondary fresh water FW2) flow, respectively.

The secondary element E2 is a reverse osmosis membrane device having the same configuration and capability as the above-mentioned primary element E1, but they are distinguished in the following description. In the vessel of the secondary element E2, a secondary flow inlet E21 connected to the secondary distribution line Ld2, and a secondary water collection port E22 and a secondary fresh water collection port E23 connected to each of the secondary water collection line Lg2 and the secondary fresh water line Lf2 are provided.

In this embodiment, the three secondary elements E2 are disposed in parallel to each other to form the secondary unit U2. The number of the secondary elements E2 in the secondary unit U2 is set to be smaller than the number of the primary elements E1 in the primary unit U1. In the present embodiment, an example in which the three secondary elements E2 are provided in the secondary unit U2 is illustrated. However, the number of the secondary elements E2 may be two, or four or more, as long as the number of the secondary elements E2 is smaller than the number of the primary elements E1.

The connection line Lc connects the downstream side of the primary unit U1 and the secondary unit U2. More specifically, the connection line Lc connects the downstream end portion of each primary water collection line Lg1 in the primary unit U1 and the upstream end portion of each secondary distribution line Ld2 in the secondary unit U2. Thereby, as the primary condensed water CW1 generated in the primary unit U1 flows in the order of the primary water collection line Lg1, the connection line Lc, and the secondary distribution line Ld2, the primary condensed water CW1 is distributed to each secondary element E2 of the secondary unit U2. In the secondary element E2, the primary condensed water CW1 is further separated and condensed to generate fresh water (secondary fresh water FW2) and secondary condensed water CW2 as the remaining components except the secondary fresh water FW2. Fresh water is recovered through the secondary fresh water line Lf2. The secondary condensed water CW2 is recovered through the secondary water collection line Lg2 and then discharged to the outside after undergoing post-treatment or the like by an external facility (not illustrated).

Furthermore, in the water treatment device 1 according to the present embodiment, the reflux unit 2 which refluxes a part of the secondary condensed water CW2 to the flow path between the primary unit U1 and the secondary unit U2 is provided. More specifically, the reflux unit 2 includes a reflux line Lc1 which branches from the secondary water collection line Lg2 and is connected to the connection line Lc, a reflux pump Pc provided on the reflux line Lc1, and a reflux valve V1 which switches the circulation state of the reflux line Lc1.

In other words, the reflux line Lc1 connects the downstream side and the upstream side of the secondary unit U2 to each other. Here, on the upstream side of the secondary unit U2, the pressure of the condensed water (primary condensed water CW1) is higher than that of the downstream side. Therefore, in the reflux unit 2 according to the present embodiment, pressure is applied from the downstream side to the upstream side along the reflux line Lc1 by the reflux pump Pc. As a result, a part of the secondary condensed water CW2 in the reflux line Lc1 circulates from the downstream side of the secondary unit U2 (on the secondary collection line Lg2) toward the upstream side (on the connection line Lc).

The reflux valve V1 is a valve device that is capable of adjusting the flow rate. That is, by adjusting the opening degree of the reflux valve V1, it is possible to adjust the amount of the secondary condensed water CW2 flowing through the reflux line Lc1.

Next, the operation of the water treatment device 1 configured as described above will be described.

In the normal operating state, the reflux valve V1 in the reflux unit 2 is closed. By driving the pump P in this state, the water to be treated SW is guided to the primary unit U1 via the water intake line L1. The water to be treated SW pressurized by the pump P flows through the reverse osmosis membrane of each primary element E1 under a high-pressure state.

In the primary unit U1, reverse osmosis with respect to the water to be treated SW is performed in each primary element E1. As a result, in the primary element E1, the primary condensed water CW1 in which salt or the like in the water to be treated SW is condensed, and the primary fresh water FW1 as remaining components except the primary condensed water CW1 (fresh water) are generated. More specifically, the fresh water component of the water to be treated SW is transmitted through the reverse osmosis membrane and reaches the downstream side to become the primary fresh water FW1. As the primary fresh water FW1 is transmitted to the downstream side, salt contained in the water to be treated SW is condensed on the upstream side of the reverse osmosis membrane. Thereby, the primary condensed water CW1 is generated on the upstream side of the reverse osmosis membrane. At the downstream side of the reverse osmosis membrane, the pressure of the primary fresh water FW1 becomes smaller than the pressure of the water to be treated SW.

The primary fresh water FW1 is recovered to the outside via the primary fresh water line Lf1. The primary condensed water CW1 is collected in the primary water collection line Lg1 and then flows into the secondary unit U2 on the downstream side via the connection line Lc. In the secondary unit U2, the primary condensed water CW1 flowing in via the connection line Lc is distributed to each secondary element E2 by the secondary distribution line Ld2, respectively.

Similarly to the primary element E1, in the secondary element E2, separation of fresh water from the primary condensed water CW1 and condensation of salts are performed. That is, the secondary fresh water FW2 which is a fresh water component in the primary condensed water CW1, and the secondary condensed water CW2 which is the remaining component except the secondary fresh water FW2 are generated.

The secondary fresh water FW2 is recovered to the outside by the secondary fresh water FW2 collection line. The secondary condensed water CW2 is collected in the secondary water collection line Lg2 and then discharged into the external environment. By continuously performing the above operations, the water to be treated SW (sea water) is desalinated.

In the water treatment device 1 as described above, a target value is predetermined with respect to a volume ratio of the fresh water recovered from the water to be treated SW (fresh water recovery rate). For example, when sea water is desalinated, the fresh water recovery rate is set to about 25 to 40%. However, when the capability of the reverse osmosis membrane deteriorates with the continuous operation of the device, the fresh water recovery rate relatively decreases and may fall below the target value. In this case, by increasing the output of the pump P, the supply pressure of the water to be treated SW to the reverse osmosis membrane increases. As the pressure of the water to be treated SW increases, the amount of fresh water separated in the reverse osmosis membrane increases, and the fresh water recovery rate starts to rise.

Meanwhile, as the fresh water recovery rate rises as described above, the amount of the secondary condensed water CW2 separated from the water to be treated SW decreases. Here, in the device using the reverse osmosis membrane, the lower limit value is set for the amount (flow rate) of condensed water to be discharged. When the amount of the condensed water falls below the lower limit value, defects such as scale precipitation occur due to an increase in membrane surface concentration caused by concentration polarization in the membrane module, and there is a possibility that sufficient separation and condensation cannot be performed.

Therefore, in the water treatment device 1 according to the present embodiment, a part of the secondary condensed water CW2 is refluxed to the upstream side of the secondary unit U2 (more specifically, on the connection line Lc between the primary unit U1 and the secondary unit U2) by the reflux unit 2. Therefore, it is possible to relatively increase the amount of the secondary condensed water CW2 discharged from the secondary element E2 in the secondary unit U2. Therefore, the amount of the secondary condensed water CW2 discharged from each of the secondary elements E2 can be made larger than the lower limit value.

Furthermore, the reflux of the secondary condensed water CW2 as described above can be easily performed only by driving the reflux pump Pc and opening the reflux valve V1. In particular, the valve device such as the reflux valve V1 can be opened and closed during water flow (operation) of the water treatment device 1. That is, in the water treatment device 1 according to the present embodiment, a part of the secondary condensed water CW2 can be refluxed to the upstream side without stopping the operation. As a result, it is possible to improve the fresh water recovery rate, without decreasing the operation rate of the water treatment device 1.

In addition, in the water treatment device 1 as described above, even if the amount of the primary condensed water CW1 decreases by increasing the fresh water recovery rate, it is possible to allow the water to flow through all the secondary elements E2 in the secondary unit U2. In other words, when the amount of the primary condensed water CW1 decreases, it is not necessary to take measures such as separation of a part of the secondary elements E2 from the system to disable the treatment. Generally, it is necessary to fill a preservative solution in the reverse osmosis membrane device (secondary element E2) in which the treatment is disabled, in order to protect the reverse osmosis membrane. However, according to the above configuration, since the condensed water flows through all the secondary elements E2, it is possible to omit a device or a process for filling the preservation solution or the like. As a result, the installation cost and the maintenance cost of the device can be reduced.

### Second Embodiment

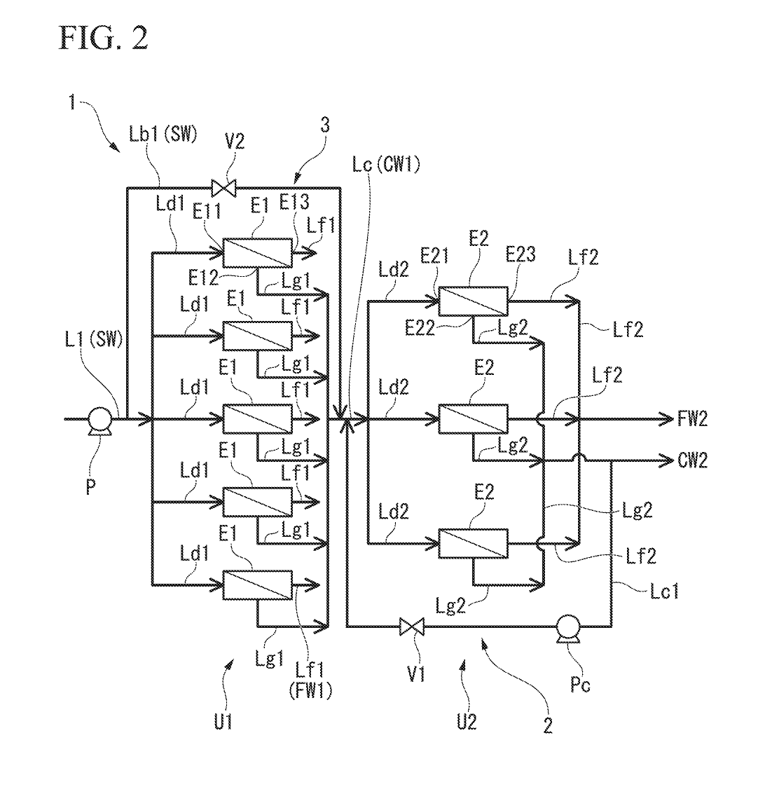

Next, a second embodiment of the present invention will be described with reference to FIG. 2. The same configurations as the aforementioned first embodiment are denoted by the same reference numerals, and a detailed description thereof will not be provided.

As illustrated in FIG. 2, in the water treatment device 1 according to the present embodiment, a bypass unit 3 is provided in addition to the reflux unit 2. More specifically, the bypass unit 3 includes a bypass line Lb1 which connects a section between the pump P on the water intake line L1 and the primary unit U1 and a section between the primary unit U1 and the secondary unit U2, and a bypass valve V2 provided on the bypass line Lb1.

By such a bypass line Lb1, a component of a part of the water to be treated SW flowing through the water intake line L1 is extracted and guided to the upstream side of the secondary unit U2, without going through the primary unit U1. In other words, a component of a part of the water to be treated SW extracted from the water intake line L1 is supplied (refluxed) as the primary condensed water CW1 to the secondary unit U2.

According to the above configuration, it is possible to relatively increase the amount of the primary condensed water CW1 guided to the secondary element E2 in the secondary unit U2. As a result, the amount of the secondary condensed water CW2 discharged from each of the secondary elements E2 can be made larger than the lower limit value of the amount of condensed water determined for each secondary element E2.

Furthermore, each manipulation of extraction and bypass of water to be treated SW as described above can be easily performed only by opening the bypass valve V2. In particular, the valve device such as the bypass valve V2 can be opened and closed during water flow (operation) of the water treatment device 1. Therefore, in the water treatment device 1 according to the present embodiment, it is possible to bypass a part of the water to be treated SW toward the secondary unit U2, without stopping the operation. As a result, it is possible to improve the fresh water recovery rate, without decreasing the operation rate of the water treatment device 1.

Each embodiment of the present invention has been described above with reference to the drawings. However, each of the above embodiments is merely an example, and various modifications can be made without departing from the scope of the present invention.

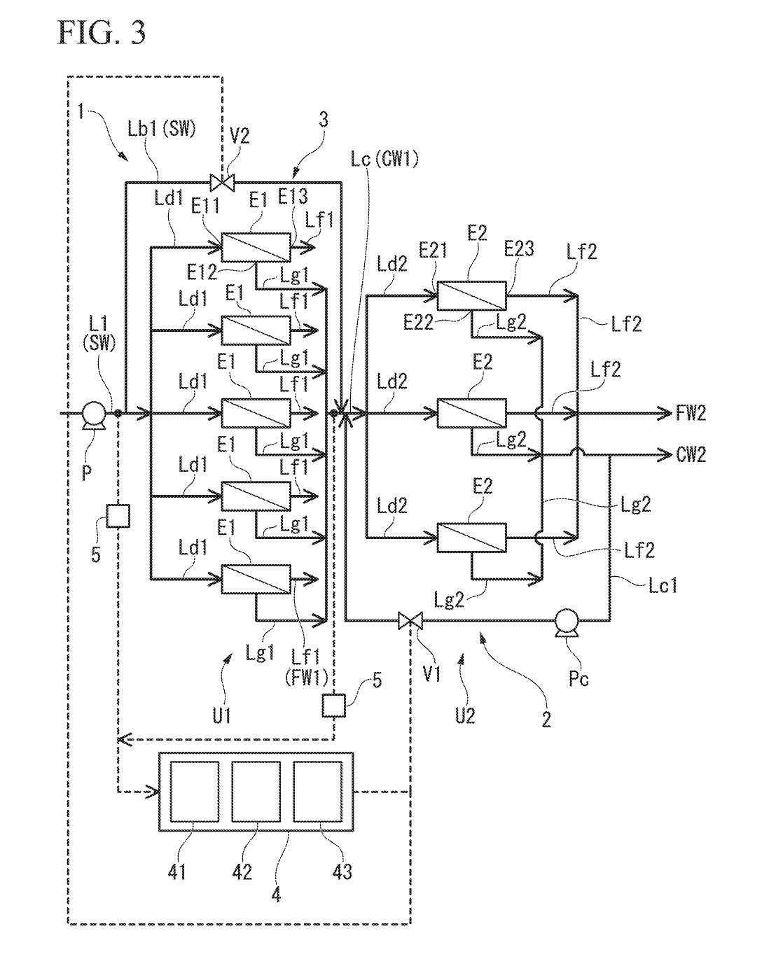

For example, when operating the reflux unit 2 and the bypass unit 3 in each of the above-described embodiments, the operation may be performed by the operator's hand or by the control unit illustrated in FIG. 3. In the case of using the control unit 4, by providing the measuring unit 5 on the water intake line L1 and on the connection line Lc, characteristic values of water (the water to be treated SW, the primary condensed water CW1, the secondary condensed water CW2, the primary fresh water FW1, and the secondary fresh water FW2) in each line are measured. On the basis of the characteristic values, the control unit 4 controls the reflux unit 2 (reflux valve V1) and the bypass unit 3 (opening and closing of the bypass valve V2).

More specifically, as the measuring unit 5, a device capable of measuring the electric conductivity of water, a thermometer, or the like is appropriately used.

The control unit 4 has a calculating unit 41 that calculates the characteristic value on the basis of values obtained by measurement of the measuring unit 5, a determining unit 42 that determines necessity of operation of the reflux unit 2 and the bypass unit 3 on the basis of the characteristic value calculated by the calculating unit 41, and a signal generating unit 43 that instructs the degree of opening of the reflux valve V1 and the bypass valve V2 as an electric signal based on the determination of the determining unit 42.

In the case of adopting the above configuration, the measuring unit 5 continuously measures characteristic values such as electric conductivity of water, temperature, LSI (Langeliar Saturation Index), and the like. The determining unit 42 in the control unit 4 compares these characteristic values with a predetermined reference value or reference range. When the reference value or the reference range is satisfied, the determining unit 42 determines that the fresh water recovery rate can be increased, and opens the reflux valve V1 and the bypass valve V2.

Further, when using the LSI as an indicator, “the case where the reference value or the reference range is satisfied” corresponds to a case where the LSI is smaller than the reference value (e.g., a case of being smaller than 0).

Further, the determination as to whether or not the fresh water recovery rate can be increased is usually performed by checking the presence or absence of scale precipitation of the element using LSI, but the same determination may be made on the basis of the electric conductivity and temperature.

Generally, the value of LSI depends on each value of electric conductivity and temperature of water to be measured. Furthermore, the electrical conductivity is determined by the dissolved salt concentration in water (i.e., the concentration of salt dissolved in the ion state as an electrolyte). Further, as the temperature of water increases by 1° C., the value of LSI increases by approximately 1.5×10⁻².

Therefore, it is also possible to provide a configuration in which, after measuring the electric conductivity and the temperature by the measuring unit 5, the calculating unit 41 in the control unit 4 calculates the LSI-converted value by performing calculation on the basis of the characteristic values. Even in this case, the determining unit 42 of the control unit 4 determines whether or not the fresh water recovery rate can increase on the basis of the LSI-converted value.

According to such a configuration, it is possible to autonomously maximize the fresh water recovery rate in accordance with the water quality of the water to be treated SW. In particular, the capability of the water treatment device 1 can flexibly respond to changes in water quality due to seasonal variations or the like.

Further, when including both the reflux unit 2 and the bypass unit 3, it is preferable to define priorities for the devices. For example, when it is necessary to raise the fresh water recovery rate, a configuration in which the reflux of the secondary condensed water CW2 is preferentially performed by the reflux unit 2 is considered. Furthermore, when, due to the reflux of the secondary condensed water CW2, the salt concentration at the inlet of the secondary unit U2 increases, the amount of fresh water (transmitted water) discharged from the primary unit U1 relatively increases, and the amount of transmitted water exceeds the permissible value, it is preferable to adopt a configuration which introduces the water to be treated SW into the secondary unit U2 by opening the bypass unit 3 (bypass line Lb1) in addition to the above configuration.

### INDUSTRIAL APPLICABILITY

According to the water treatment device 1 and the method of operating the water treatment device 1 described above, it is possible to improve the fresh water recovery rate and the operation rate.

### REFERENCE SIGNS LIST

1 Water treatment device

2 Reflux unit

3 Bypass unit

4 Control unit

41 Calculating unit

42 Determining unit

43 Signal generating unit

5 Measuring unit

CW1 Primary condensed water

CW2 Secondary condensed water

E1 Primary element

E11 Primary flow inlet

E12 Primary water collection port

E13 Primary fresh water collection port

E2 Secondary element

E21 Secondary flow inlet

E22 Secondary water collection port

E23 Secondary fresh water collection port

FW1 Primary fresh water

FW2 Secondary fresh water

L1 Water intake line

Lb1 Bypass line

Lc Connection line

Lc1 Reflux line

Ld1 Primary distribution line

Ld2 Secondary distribution line

Lf1 Primary fresh water line

Lf2 Secondary fresh water line

Lg1 Primary water collection line

Lg2 Secondary water collection line

P Pump

Pc Reflux pump

SW Water to be treated

U1 Primary unit

U2 Secondary unit

V1 Reflux valve

V2 Bypass valve

1. A water treatment device comprising:
a primary unit having a plurality of primary elements as reverse osmosis membrane devices disposed in parallel to each other to separate water to be treated supplied from an upstream side into primary condensed water and fresh water;
a pump which feeds the water to be treated from the upstream side of the primary unit to supply the water to be treated to the primary unit;
a secondary unit having secondary elements as reverse osmosis membrane devices, the secondary elements being provided in smaller number than the primary elements and disposed in parallel to each other to separate the primary condensed water into secondary condensed water and fresh water; and
a reflux unit which refluxes a part of the secondary condensed water between the primary unit and the secondary unit.

2. The water treatment device according to claim 1, further comprising:
a reflux line through which the secondary condensed water flows, by connecting the downstream side of the secondary unit and the upstream side of the secondary unit; and
a reflux pump provided on the reflux line to feed the secondary condensed water flowing through the reflux line toward the upstream side of the secondary unit.

3. The water treatment device according to claim 1, further comprising:
a bypass line which bypasses a part of the water to be treated from a section between the pump and the primary unit to a section between the primary unit and the secondary unit.

4. The water treatment device according to claim 1, further comprising:
a measuring unit which measures characteristic value of at least one of the water to be treated, the primary condensed water, the secondary condensed water, and the fresh water; and
a control unit which controls reflux of the secondary condensed water by the reflux unit, on the basis of a comparison between a Langeliar saturation index obtained from the characteristic value and a predetermined reference value.

5. The water treatment device according to claim 4, wherein the characteristic value is a temperature or electric conductivity in at least one of the water to be treated, the primary condensed water, the secondary condensed water, and the fresh water, and
the control unit includes a calculating unit which calculates the Langeliar saturation index on the basis of the temperature and the electric conductivity.

6. The water treatment device according to claim 2, further comprising:
a bypass line which bypasses a part of the water to be treated from a section between the pump and the primary unit to a section between the primary unit and the secondary unit.

7. The water treatment device according to claim 2, further comprising:
a measuring unit which measures characteristic value of at least one of the water to be treated, the primary condensed water, the secondary condensed water, and the fresh water; and
a control unit which controls reflux of the secondary condensed water by the reflux unit, on the basis of a comparison between a Langeliar saturation index obtained from the characteristic value and a predetermined reference value.

8. The water treatment device according to claim 3, further comprising:
a measuring unit which measures characteristic value of at least one of the water to be treated, the primary condensed water, the secondary condensed water, and the fresh water; and
a control unit which controls reflux of the secondary condensed water by the reflux unit, on the basis of a comparison between a Langeliar saturation index obtained from the characteristic value and a predetermined reference value.
